(19) United States
(12) Patent Application Publication
(10) Pub. No.: US 2012/0267882 A1
(43) Pub. Date: Oct. 25, 2012

(54) Method To Achieve Early/Robust G-Signal For Side Pole

(75) Inventors: Lando Crispin Hamlett, Marysville, OH (US); Hajime Ishida, Dublin, OH (US); Siyang Yang, Dublin, OH (US)

(73) Assignee: HONDA MOTOR CO., LTD., Tokyo (JP)

(21) Appl. No.: 13/089,844

(22) Filed: Apr. 19, 2011

(51) Int. Cl. B60R 21/21; B62D 25/20; B62D 25/04

(52) U.S. Cl. 280/735; 296/193.06; 296/209

(57) ABSTRACT

The embodiments herein describe a fundamental layout between the inner panel of a door, side sill reinforcement, and uncrushable items within the door of the vehicle. During a side impact collision, a side impact sensor receives a G-signal resulting from the collision. The G-signal must ramp up to a threshold value in order to deploy the side airbag. The fundamental layout between the inner panel of a door, side sill reinforcement, and uncrushable items within the door of the vehicle ensures a more robust G-signal which results in early deployment of the side airbag relative to the movement of the door toward the occupant.

### FIELD OF THE INVENTION

The embodiments disclosed herein relate generally to improving the time in which side airbags deploy in vehicles, and more particularly to a layout guideline of the components of a vehicle body that contribute to the improvement of the time in which a side airbag deploys.

### BACKGROUND

By law, all new vehicle models must pass certain safety tests before they are sold to the public. However, these safety tests typically provide a minimum statutory standard of safety for new vehicles. Many independent safety assessment programs have been developed, such as the New Car Assessment Program (NCAP), which provide a higher standard of safety for new vehicles. These programs assign safety ratings to new vehicles that describe how well the vehicles performed in various safety tests which include side impact collisions at a fixed velocity (e.g., 32 km/h for oblique pole collisions). Safety ratings are awarded to vehicles based on the level of injury an occupant of the vehicle would have sustained in the collisions performed during the tests.

The use of inflatable airbags stored in various locations of the vehicles such as in the steering wheel, dashboard, seats, or doors have substantially reduced the level of injury inflicted on occupants of the vehicles during a collision. To further reduce the level of injury during collisions, vehicle manufacturers constantly strive to improve the time needed to deploy airbags in their vehicles. The time of deployment describes the time period between the moment of initial impact during a collision and when the airbag deploys. A fast deployment time is desired in order to prevent an occupant from colliding with the interior of the vehicle such as the door.

Airbag restraint systems typically include an impact sensor which triggers deployment of the airbag. For example, for side airbag systems, many vehicle manufacturers use door pressure sensors. Door pressure sensors are effective for early detection of a side impact collision. However, these pressure sensors are expensive. Due to their lower cost, vehicle manufactures use accelerometers or G-sensors as an alternative to pressure sensors to detect side impact collisions. An issue with G-sensor based side impact sensors is that the initial side impact signal received at the sensors during a side impact collision tests is not strong enough to trigger the deployment of the side airbag. In other words, G-sensor based side impact sensors result in a later time of deployment of the side airbag.

Referring now to FIG. 1A, various layouts of side impact restraint systems are shown. Although not shown in FIG. 1A, the side impact restraint systems typically include a side airbag restraint system. Generally, vehicle manufacturers add a door beam 101A to a vehicle door that is horizontally positioned across the door as shown in FIG. 1A. The door beam 101A reduces the intrusion of the door into the vehicle cabin during a side impact collision. During a side impact collision, the force of the collision is transferred from the door beam 101A to the side impact sensor 103 through the structure of the door and the vehicle body. However, tests have concluded that the initial side impact signal received at the side impact sensor 103 still results in a delayed time to fire of the side airbag.

In alternative configurations, rather than having the door beam 101A span horizontally across the door, the angle of the door beam is changed as shown by door beam 101B. The door beam 101B is positioned such that one end of the door beam 101B is pointed in the downward (angled) position and is located in close proximity to the side impact sensor 103. Additionally, a bracket 105 is added to stiffen the door beam 101B as illustrated in FIG. 1B. By stiffening the door beam 101B with the bracket 105, the force of the side impact collision is better transferred to the side impact sensor 103. However, the bracket-door beam configuration still results in an initial side impact signal that lacks robustness thereby resulting in a late time of deployment of the side airbag in low speed impacts.

### SUMMARY

Embodiments herein describe a fundamental layout between the inner panel of a door, side sill reinforcement, and uncrushable items within the door of the vehicle. The position of these components with respect to one another dictates whether a side airbag in the vehicle can be quickly deployed during a side impact collision. During a side impact collision, an early time of deployment is desirable in order to allow the side airbag to fully expand before an occupant of the vehicle collides with the side airbag. Full expansion of the side airbag minimizes the risk of injury during a side impact collision.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIGS. 1A and 1B illustrate prior art side impact restraint configurations according to one embodiment.

FIG. 2 illustrates the spatial relationship between an occupant of a vehicle and the door of the vehicle according to one embodiment.

FIG. 3 illustrates the fundamental layout between an inner door panel, side sill reinforcement, and uncrushable items in a vehicle door to achieve an early time of deployment of a side airbag according to one embodiment.

FIGS. 4A, 4B, and 4C illustrate a side impact collision with a pole according to one embodiment.

FIG. 5 illustrates the offset layout of the side sill reinforcement and side sill inner according to one embodiment.

FIGS. 6A-6D illustrate the deformation of a conventional side sill reinforcement according to one embodiment.

FIGS. 7A-7D illustrate the deformation of a side sill reinforcement with a minimized offset according to one embodiment.

FIG. 8 illustrates a system diagram of a vehicle according to one embodiment.

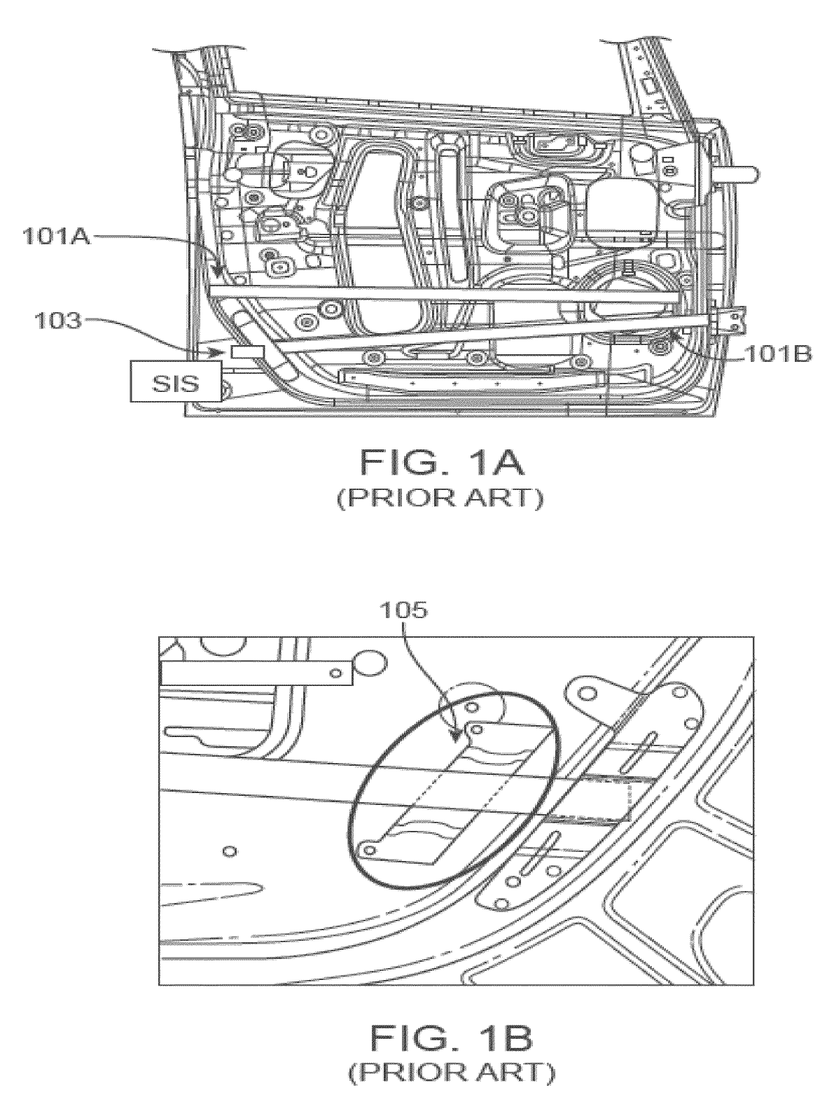

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A preferred embodiment is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Certain aspects disclosed herein include process steps and instructions described herein in the form of an algorithm. It should be noted that the process steps and instructions herein could be embodied in software, firmware or hardware, and when embodied in software, could be downloaded to reside on and be operated from different platforms used by a variety of operating systems. The process steps and instructions can also be in a computer program product which can be executed on a computing system.

The disclosure also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the disclosure is not described with reference to any particular programming language. It will be appreciated that a variety of programming languages may be used to implement the teachings as described herein, and any references below to specific languages are provided for disclosure of enablement and best mode.

In addition, the language used in the specification has been principally selected for readability and instructional purposes, and may not have been selected to delineate or circumscribe the inventive subject matter. Accordingly, the disclosure herein is intended to be illustrative, but not limiting, of the scope of the invention, which is set forth in the claims.

### Fundamental Layout

In the following description, a fundamental layout between the inner panel of a door, side sill reinforcement, and the uncrushable items within the door of a vehicle is described. The layout of the inner panel, side sill reinforcement, and the uncrushable items in relation to each other dictates whether an early time to fire of a side airbag during a side impact collision can be achieved. In one embodiment, the time to fire or the time of deployment describes the interval of time from the initial side impact collision to the deployment of the side airbag. The layout described herein may be applied to any vehicle to achieve an initial side impact signal that results in an early time to fire of an airbag.

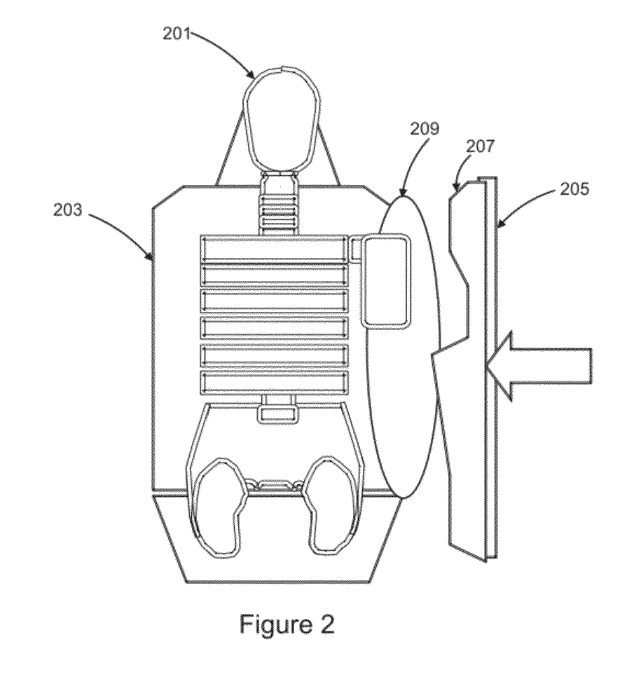

Referring now to FIG. 2, an illustration of an occupant 201 in a seat or chair 203 of a vehicle is shown with respect to a door 205 of the vehicle. The occupant 201 of the vehicle may be the driver of the vehicle or a passenger of the vehicle. As shown in FIG. 2 in one embodiment, the door 205 of the vehicle comprises a door liner 207. The door liner 207 is the portion of the door that is visible to the occupant 201 while inside the interior region of the vehicle. The door liner 207 generally includes an arm rest for the occupant, window controls, and door controls and may comprise other components. During a side impact collision, the door 205 is displaced towards the occupant 201 of the vehicle causing the occupant to impact the door liner 207. To reduce the occupant 201′s injury resulting from impacting the intruding door liner 207, a side airbag 209 is deployed.

Generally, a minimum horizontal distance (e.g., 80 mm) is needed to fully deploy the side airbag 209. To minimize the amount of trauma during a side impact collision, the side airbag 209 should be fully deployed before the occupant 201 comes into contact with the side airbag 209. This allows the occupant 201 to fully utilize the entire stroke of the side airbag 209. During a side impact collision test at 32 km/h as defined by NCAP (other velocities may be defined in future assessment programs), development tests indicate that the side airbag 209 must be deployed by some time threshold (e.g., 7.5 ms) after movement of the door 205 towards the occupant 201 in order to minimize injury to the occupant 201. By deploying the side airbag 209 by the time threshold after the side impact collision, the side airbag 209 can utilize its full expansion stroke thereby providing enough cushion to protect the occupant 201 from injury.

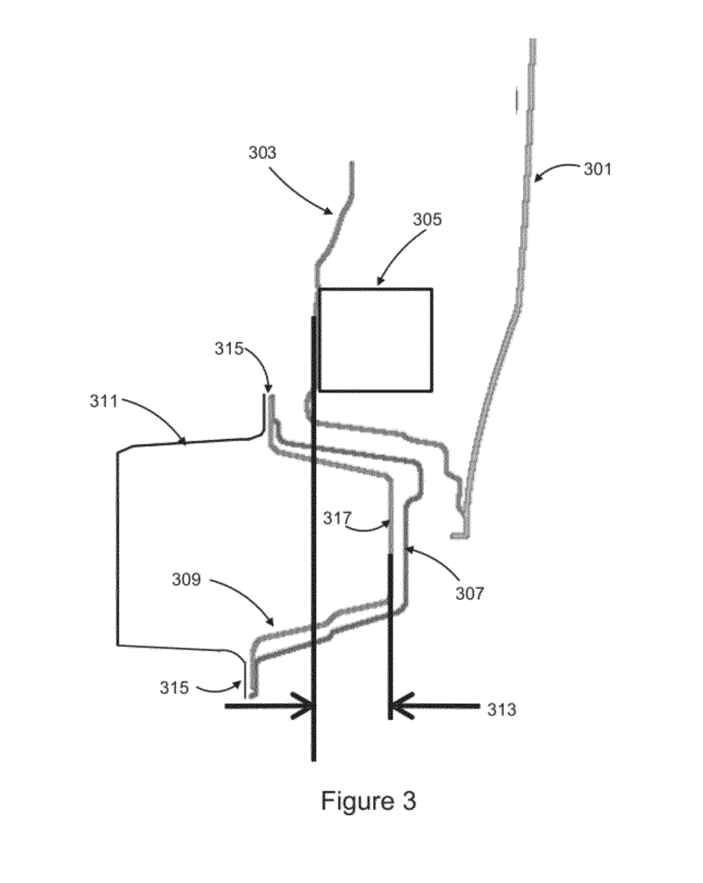

Referring now to FIG. 3, there is shown one embodiment of a fundamental layout between the inner panel 303 of a vehicle door, the side sill reinforcement 309, and the uncrushable items 305 within the door. The spatial relationship between these components dictates whether an early deployment (i.e., by the time threshold) of the side airbag can be achieved using only G-sensor based side impact sensors such as those supplied by Denso, TRW, Continental or other manufacturers of impact sensors. Note that hereafter, the term “side impact sensor” refers to a G-sensor or accelerometer based side impact sensor. The side impact sensor may be mounted on various locations of the vehicle. For example, the side impact sensor may be mounted on any of the vertical supports of the vehicle otherwise known as the pillars of the vehicle such as the A-pillar, B-pillar, C-pillar, or D-pillar. The side impact sensor may also be located at other locations within the vehicle such as within the door or inside the vehicle cabin.

In particular, FIG. 3 illustrates a cross section of a vehicle side structure including the door and side sill of the vehicle. The door comprises a door skin 301. The door skin 301 is the exterior surface of the door that is visible from outside of the vehicle. Furthermore, the door comprises an inner door panel 303 which is located in the interior cabin of the vehicle. The inner door panel 303 is typically hidden from the occupants of the vehicle since the door liner (not shown) is mounted to the inner door panel 303. The door skin 301 and inner door panel 303 are coupled to one another via various means such as welding, hemming, press fitting, or using fasteners such as rivets or a nut(s) and bolt(s). The door skin 301 and inner door panel 303 may be made of various materials such as steel, aluminum, or a composite material.

Additionally, the space between the inner door panel 303 and the door skin 301 includes uncrushable items 305. In one embodiment, the uncrushable items 305 are items located within the door that are resistant to being crushed during a collision. The uncrushable items 305 are represented by a square in FIG. 3. Examples of the uncrushable items include the window motor and door beam located within the door.

The side sill is part of the side structure of the vehicle that is coupled to the pillars of the vehicle. The side sill comprises a side sill outer panel 307, side sill reinforcement 309, and side sill inner 311. The side sill outer panel 307, side sill reinforcement 309, and side sill inner 311 are coupled to one another at flanges 315 via various means such as welding, hemming, press fit, or using fasteners such as rivets or a nut(s) and bolt(s).

During a side impact collision, the side sill reinforcement 309 transfers the force of the collision through the side sill inner 311 (and/or through the vehicle body) and into the side impact sensor. Using the side sill reinforcement 309 to transfer the force of the collision causes the sensor to trigger the deployment of the side airbag sensor within the required or threshold amount of time from the initial movement of the inner door panel 303 due to the collision. In order to effectively use the side sill reinforcement 309 to transfer the force of the collision to the sensor, the inner door panel 303, uncrushable items 305, and side sill reinforcement 309 are strategically arranged in a fundamental layout that results in a foreign object (e.g., a pole) coming into contact with the side sill reinforcement 307. The contact between the object and side sill reinforcement 309 results in a G-build up at the side impact sensor which triggers the deployment of the side airbag within the required amount of time.

In one embodiment, the fundamental layout between the inner door panel 303, uncrushable items 305, and side sill reinforcement 309 is characterized by the following relationship:

UI−(InnrPanel to RNFCT)≦25 mm

In the above relationship, the horizontal width of the uncrushable items (UI) minus the distance 313 from the inner door panel 303 (InnrPanel) to a vertical support 317 of the side sill reinforcement 309 (RNFCT) must be less than or equal to 25 mm. In another embodiment, the difference must be less than or equal to 30 mm. In an alternative embodiment, the different must be less than or equal to 20 mm. By minimizing the horizontal space between these components of the vehicle, the contact between the side sill reinforcement 309 and the foreign object causes a G-ramp (i.e., fast rate of acceleration) at the side impact sensor which triggers the deployment of the side airbag within the required time (i.e., within a time threshold).

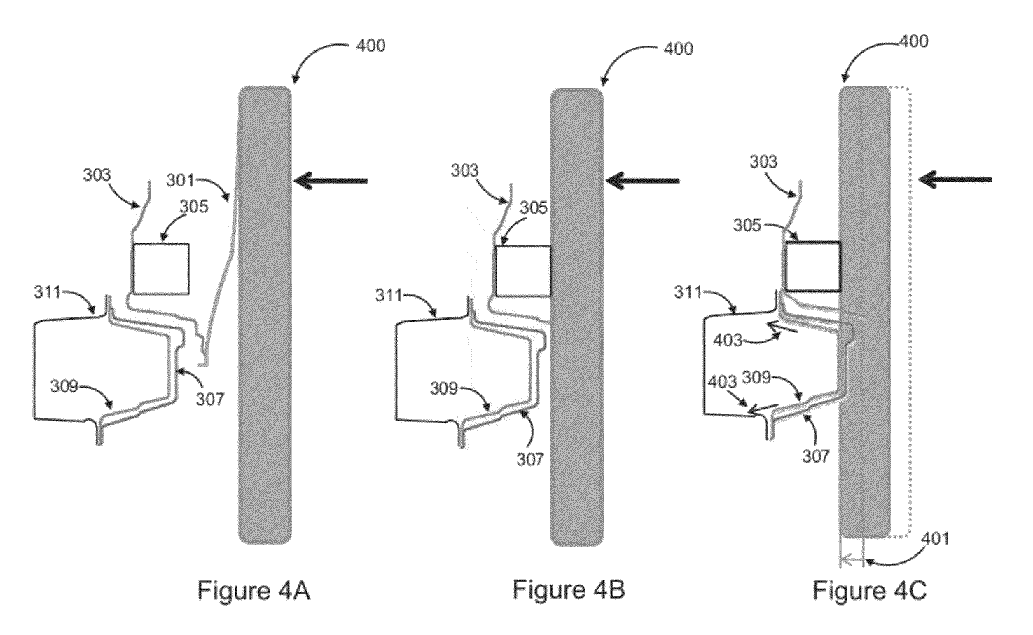

Referring now to FIGS. 4A, 4B, and 4C, the figures illustrate a side impact collision with a pole 400. In one embodiment, the collision is at a velocity of 32 km/h as defined by the NCAP side impact collision test. FIG. 4A illustrates the pole's initial contact with the door skin 301 of the vehicle. In FIG. 4B, the pole 400 has come into contact with the uncrushable items 305 within the door of the vehicle. The uncrushable items 305 are stacked up against the inner door panel 303 due to the pole 400's intrusion into the vehicle. Because the uncrushable items 305 cannot be further compressed by the pole 400, any further intrusion of the pole 400 causes the inner door panel 303 to move into the interior cabin of the vehicle towards the occupant. Thus, the relative distance between the occupant of the vehicle and the door liner 207 (which is connected to the inner door panel 301) decreases until impact between the occupant and the door liner occurs. From the stack up condition shown in FIG. 4B, side impact sensor must trigger the deployment of the side airbag by the required time in order to utilize the full stroke of the airbag. As previously discussed, occupant injury is minimized when the side airbag is fully deployed before occupant contact occurs.

In FIG. 4C, the pole 400 has pushed the uncrushable items 305 towards the interior of the vehicle thereby displacing the inner door panel 301 towards the occupant of the vehicle. Additionally, the pole 400 has contacted the side sill reinforcement 309. The pole's contact with the side sill reinforcement 309 transfers the force (represented by the arrows 403 between the side sill inner 311 and side sill reinforcement 309) of the collision through the side sill inner 311 to the side impact sensor. Due to the fundamental layout of the vehicle side structure described herein, the G-signal sensed at the side impact sensor ramps up to a minimum value needed to trigger the deployment of the side airbag within the required time relative to the movement of the inner door panel 303.

Note that FIG. 4C illustrates the pole's previous position shown in FIG. 4B by the dotted line. Comparing the previous position of the pole with the position of the pole while in contact with the side sill reinforcement 309 illustrates that the pole 400 moved a maximum distance 401 of 25 mm until contact was made with the side sill reinforcement 309. The early contact results in the quick deployment of the side airbag.

### Side Sill Reinforcement Offset

In one embodiment, to improve the transfer of force from the collision of the pole 400 and the side sill reinforcement 309, a fundamental relationship also exists between the offset or overlap of the side sill reinforcement 309 and the side sill inner 311. As previously mentioned, the force of the impact with the pole 400 is transferred from the side sill reinforcement 309 to the side sill inner 311 before being transferred to the side impact sensor. The relationship of the offset of the side sill reinforcement 309 and the side sill inner 311 allows for the collision G-signal to be transferred to the side impact sensor before the side sill reinforcement 309 is deformed as a result of the collision.

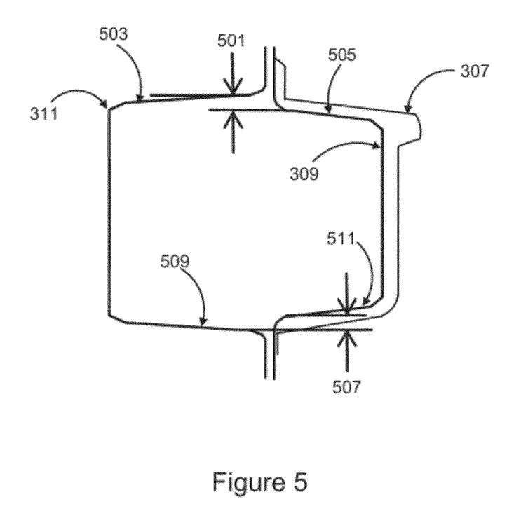

Referring now to FIG. 5, to prevent deformation of the side sill reinforcement 309 during a side impact collision before the resulting G-signal of the collision is transferred to the side impact sensor, the offset between the side sill reinforcement 309 and the side sill inner 311 is minimized. Deformation of the side sill reinforcement 309 is undesirable since the amount of force transferred to the side impact sensor is reduced because the force is dissipated in the deformation of the reinforcement 309. This results in a late deployment of the side airbag. By delaying the deformation of the side sill reinforcement 309 during a side impact collision, the strength of the side airbag signal is maintained in order to deploy the side airbag within the required time from the movement of the inner door panel 303.

The vertical offset 501 between the top horizontal edge 503 of the side sill inner 311 and the top horizontal edge 505 of the side sill reinforcement 309 is minimized to a threshold distance. In one embodiment, the vertical offset 501 is less than or equal to 3 mm. Similarly, the vertical offset 507 between the bottom horizontal edge 509 of the side sill inner 311 and the bottom horizontal edge 511 of the side sill reinforcement 309 is minimized to a threshold distance. In one embodiment, the vertical offset 507 is less than or equal to 8 mm. Note that in other embodiments, other vertical offsets may be used other than those described herein in order to prevent deformation of the side sill reinforcement 309 during a side impact collision before the G-signal is transferred to the side impact sensor.

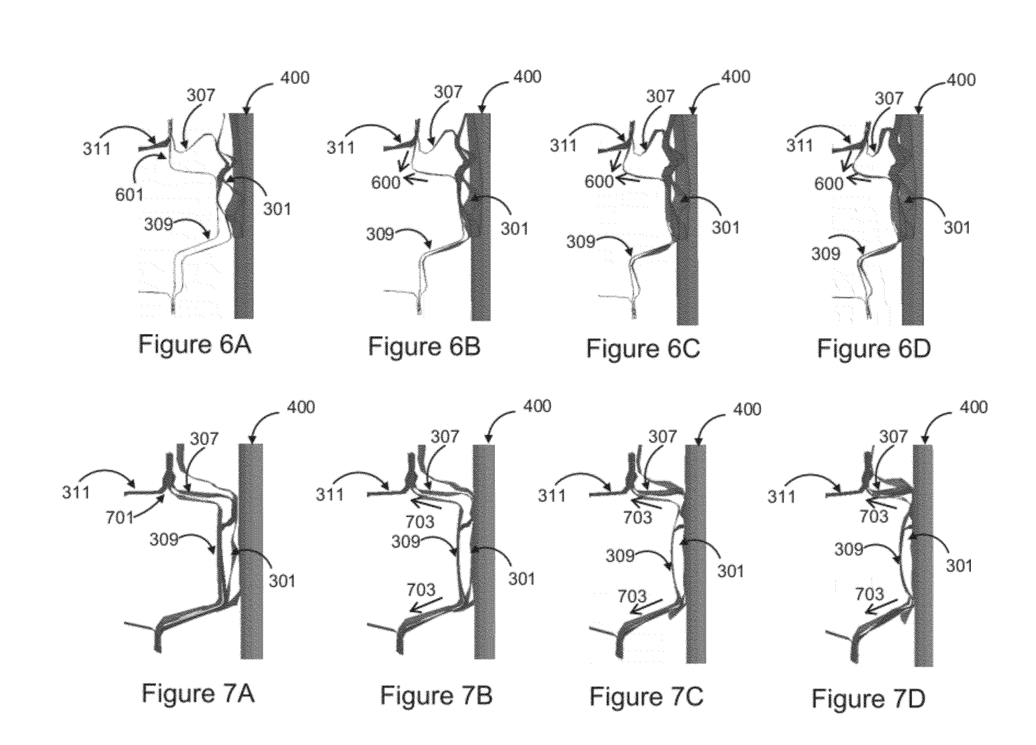

Referring now to FIGS. 6A through 6D, the deformation of the side sill reinforcement 309 during a side impact collision is illustrated in conventional systems. In FIG. 6A, the pole 400 has initially come into contact with the side sill reinforcement 309. As shown in FIG. 6A, the door skin 301 and side sill outer 307 have already deformed due to the collision. The side sill reinforcement 309 still maintains its form. However, as illustrated in FIGS. 6B through 6D, as the force of the collision with the pole 400 is transferred from the side sill reinforcement 309 to the side sill inner 311, the side sill reinforcement 309 begins to deform 600 in shape as indicated by the arrows in FIGS. 6B through 6D. The deformation 600 dissipates the amount of force transferred through the side sill inner 311 and into the side impact sensor. In conventional systems, the side sill reinforcement 309 deforms due to the larger offset 601 between the top horizontal edge of the side sill inner 311 and the top horizontal edge of the side sill reinforcement 309 compared to the minimized offset described previously. The larger offset 601 creates a longer moment arm which causes the side sill reinforcement 309 to deform in shape thereby reducing the amount of force that is delivered to the side impact sensor since the force is dissipated in the deformation of the reinforcement.

Referring now to FIGS. 7A through 7D, the deformation 703 of the side sill reinforcement 309 during a side impact collision is illustrated with respect to one embodiment of the disclosure. As shown in FIGS. 7A-7D, the offset 701 between the top horizontal edge of the side sill reinforcement 309 and the top horizontal edge of the side sill inner 311 is minimized compared to offset 601 illustrated in the structure shown in FIGS. 6A through 6D. Because the vertical offset 701 between the side sill reinforcement 309 and side sill inner 311 is minimized, the amount of deformation 703 of the side sill reinforcement 309 during a side impact collision is also minimized as illustrated in FIGS. 7A through 7D. This allows the side airbag to be deployed within the required time as previously described.

### Vehicle System

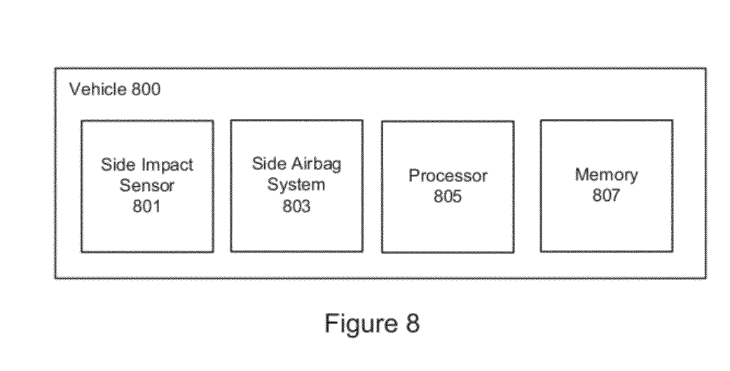

Referring now to FIG. 8, there is shown one embodiment of a vehicle 800. In one embodiment, the vehicle 800 comprises a side impact sensor 801, a side airbag system 803, a computer processor 805, and a memory 807. Although only one side impact sensor 801 and side airbag system 803 is shown, the vehicle 800 may include any number of side impact sensors and side airbag systems. In other embodiments, the vehicle 800 may include components other than those illustrated in FIG. 8.

In one embodiment, the side impact sensor 801 is located on the B-pillar of the vehicle 800. However, the side impact sensor 801 may be located at different locations on the vehicle 801. As described previously, the side impact sensor 801 is a G-based sensor (accelerometer) that measures the acceleration due to a side impact collision causing the side airbag system 803 to deploy the side airbag. When a threshold acceleration is reached, the side impact sensor communicates the measured acceleration with the processor 805.

In one embodiment, the processor 805 processes data signals such as the side airbag signal and may comprise various computing architectures including a complex instruction set computer (CISC) architecture, a reduced instruction set computer (RISC) architecture, or an architecture implementing a combination of instruction sets. Although only a single processor is shown in FIG. 8, multiple processors may be included. The processor 805 may comprise an arithmetic logic unit, a microprocessor, a general purpose computer, or some other information appliance equipped to transmit, receive and process electronic data signals from the memory 807, and side impact sensor 801.

In one embodiment, the memory 807 stores instructions and/or data that may be executed by processor 805. The instructions and/or data may comprise code (i.e., modules) for performing any and/or all of the techniques described herein such as causing the side airbag system 803 to deploy responsive to the side airbag signal received by the processor 805. Memory 807 may be any non-transitory computer-readable storage medium such as dynamic random access memory (DRAM) device, a static random access memory (SRAM) device, Flash RAM (non-volatile storage), combinations of the above, or some other memory device known in the art.

While particular embodiments and applications have been illustrated and described herein, it is to be understood that the disclosure is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A body structure of a vehicle, the structure comprising:
a door including an inner door panel and uncrushable items within the door; and
a side sill including a side sill reinforcement;
wherein a physical layout of the door relative to the side sill is such that a difference of a width of the uncrushable items within the door and a horizontal distance from the inner door panel to a vertical support of the side sill reinforcement is a maximum of 30 millimeters, the physical layout conducive to transferring a force of a side impact collision to a side airbag sensor that triggers deployment of a side airbag within a time threshold from the side impact collision.

2. The body structure of claim 1, wherein the door further includes a door skin and the uncrushable items are located between the inner door panel and the door skin.

3. The body structure of claim 1, wherein the side impact collision is with a pole.

4. The body structure of claim 3, wherein the side impact collision is with a pole at a velocity defined by an independent safety assessment program.

5. The body structure of claim 4, wherein the velocity is up to 32 kilometers per hour.

6. The body structure of claim 1, wherein the uncrushable items comprise at least one of a door beam and window motor.

7. The body structure of claim 1, wherein the side sill further includes a side sill inner comprising a first horizontal support and a second horizontal support.

8. The body structure of claim 7, wherein the first horizontal support of the side sill inner is coupled to a first horizontal support of the side sill reinforcement at a first flange and the second horizontal support of the side sill inner is coupled to a second horizontal support of the side sill reinforcement at a second flange.

9. The body structure of claim 8, wherein a first vertical offset between the first horizontal support of the side sill inner and the first horizontal support of the side sill reinforcement is a maximum of 3 millimeters.

10. The body structure of claim 8, wherein a second vertical offset between the second horizontal support of the side sill inner and the second horizontal support of the side sill reinforcement is a maximum of 8 millimeters.

11. The body structure of claim 1, wherein the difference of the width of the uncrushable items within the door and the horizontal distance from the inner door panel to a vertical support of the side sill reinforcement is a maximum of 25 millimeters.

12. The body structure of claim 1, wherein the difference of the width of the uncrushable items within the door and the horizontal distance from the inner door panel to a vertical support of the side sill reinforcement is a maximum of 20 millimeters.

13. A computer-implemented method for deploying a side airbag in a vehicle comprising a door that includes an inner door panel and uncrushable items within the door and the vehicle further comprising a side sill including a side sill reinforcement, the method comprising:
receiving a side impact signal generated from a side impact collision with the side sill reinforcement of the vehicle, wherein the side sill reinforcement is positioned such that a difference of a width of the uncrushable items within the door and a horizontal distance from the inner door panel to a vertical support of the side sill reinforcement is a maximum of 30 millimeters; and
responsive to receiving the side impact signal, causing a side airbag to deploy within a threshold of time.

14. The computer-implemented method of claim 13, wherein the side impact collision is with a pole.

15. The computer-implemented method of claim 14, wherein the side impact collision is with a pole at a velocity defined by an independent safety assessment program.

16. The computer-implemented method of claim 15, wherein the velocity is up to 32 kilometers per hour.

17. The computer-implemented method of claim 13, wherein the threshold of time is measured from initial movement of the inner door panel as a result of the collision with the side sill reinforcement.

18. The computer-implemented method of claim 17, wherein the threshold of time is 7.5 milliseconds.
